(19) United States
(12) Patent Application Publication
(10) Pub. No.: US 2020/0338757 A1
(43) Pub. Date: Oct. 29, 2020

(54) Horizontal Articulated Robot

(71) Applicant: Seiko Epson Corporation, Tokyo (JP)

(72) Inventors: Tomohisa IWAZAKI, Shimosuwa (JP); Yutaka ARAKAWA, Hara (JP)

(21) Appl. No.: 16/855,008

(22) Filed: Apr. 22, 2020

(30) Foreign Application Priority Data
Apr. 23, 2019 (JP) 2019-081622

(51) Int. Cl. B25J 18/02; F16C 19/06

(52) U.S. Cl. CPC B25J 18/02; F16C 2361/00; F16C 19/06

(57) ABSTRACT

A horizontal articulated robot includes a base, a first arm configured to turn around a turning axis that passes through the base, a second arm provided in the first arm and configured to slide with respect to the first arm to extend and contract, and a driving source configured to generate a driving force for causing the second arm to slide with respect to the first arm. When the second arm contracted, the second arm overlaps the base in a plan view from an axial direction of the turning axis. The driving source is provided in the first arm. The driving source deviates from the base in the plan view.

The present application is based on, and claims priority from JP Application Serial Number 2019-081622, filed Apr. 23, 2019, the disclosure of which is hereby incorporated by reference herein in its entirety.

### BACKGROUND

### 1. Technical Field

The present disclosure relates to a horizontal articulated robot.

### 2. Related Art

JP-A-2016-41453 (Patent Literature 1) discloses a horizontal articulated robot configured by a base, a first arm set to be rotatable in a two-dimensional plane with respect to the base, a second arm set to be rotatable within the two-dimensional plane with respect to the first arm, a guide shaft movable in the up-down direction orthogonal to the two-dimensional plane with respect to the second arm, and a work gripping mechanism such as a chuck provided at the distal end of the guide shaft.

In such a horizontal articulated robot, the work gripping mechanism is moved to a target position by appropriately setting rotation angles of the first arm and the second arm in the two-dimensional plane. Work such as gripping of work can be performed in the target position.

However, in the robot described in Patent Literature 1, unless sufficient spaces are set in a movable region of the first arm and a movable region of the second arm, the second arm collides with an obstacle when the distal end portion of the second arm approaches the base.

### SUMMARY

A horizontal articulated robot according to an application example of the present disclosure includes: a base; a first arm configured to turn around a turning axis that passes through the base; a second arm provided in the first arm and configured to slide with respect to the first arm to extend and contract; and a driving source configured to generate a driving force for causing the second arm to slide with respect to the first arm. When contracted, the second arm overlaps the base in a plan view from an axial direction of the turning axis.

### BRIEF DESCRIPTION OF THE DRAWINGS

FIG. 1 is a side view showing a horizontal articulated robot according to a first embodiment and showing a state in which a second arm is contracted with respect to the first arm.

FIG. 2 is a sectional view enlarging and showing the vicinity of a coupling section of a base and the first arm shown in FIG. 1.

FIG. 3 is a side view showing the horizontal articulated robot according to the first embodiment and showing a state in which the second arm is extended with respect to the first arm.

FIG. 4 is a plan view of the horizontal articulated robot shown in FIG. 1 viewed from the axial direction of a turning axis.

FIG. 5 is an exploded perspective view of the first arm, the second arm, and a driving device shown in FIG. 1.

FIG. 6 is a side view showing a horizontal articulated robot according to a second embodiment and showing a state in which a second arm is contracted with respect to the first arm.

FIG. 7 is a plan view of the horizontal articulated robot shown in FIG. 6 viewed from the axial direction of a turning axis.

FIG. 8 is a partially enlarged sectional view showing a horizontal articulated robot according to a third embodiment.

### DESCRIPTION OF EXEMPLARY EMBODIMENTS

Preferred embodiments of the present disclosure are explained in detail below with reference to the accompanying drawings.

### 1. First Embodiment

First, a horizontal articulated robot 1 according to a first embodiment is explained.

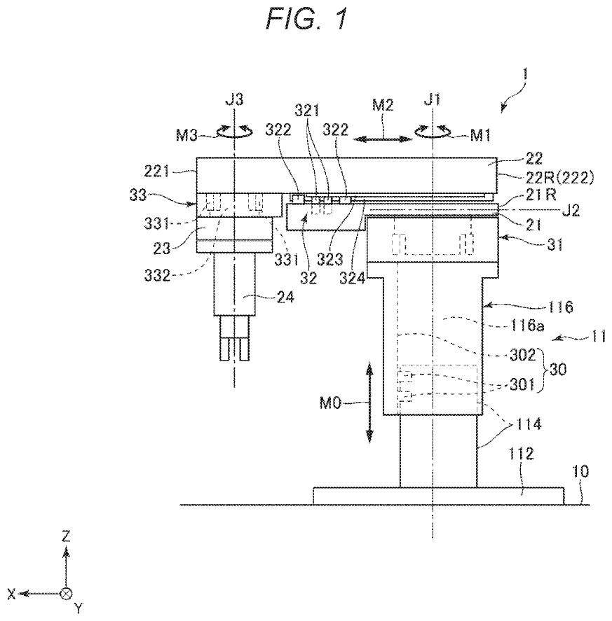

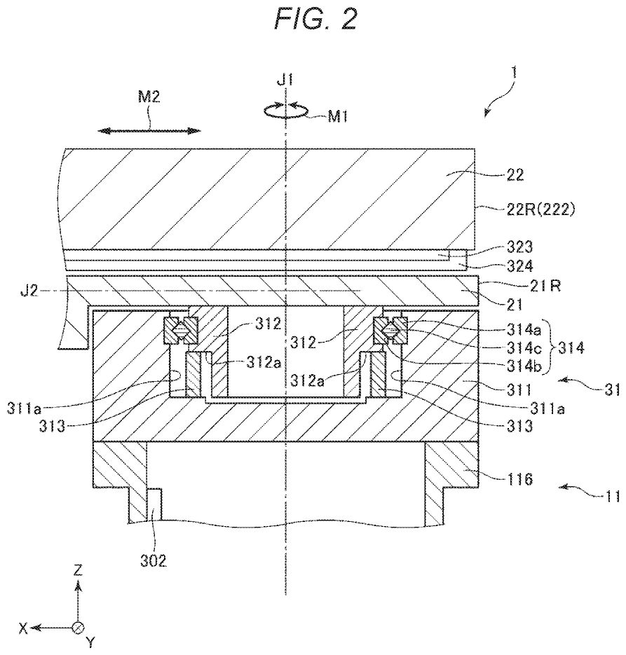

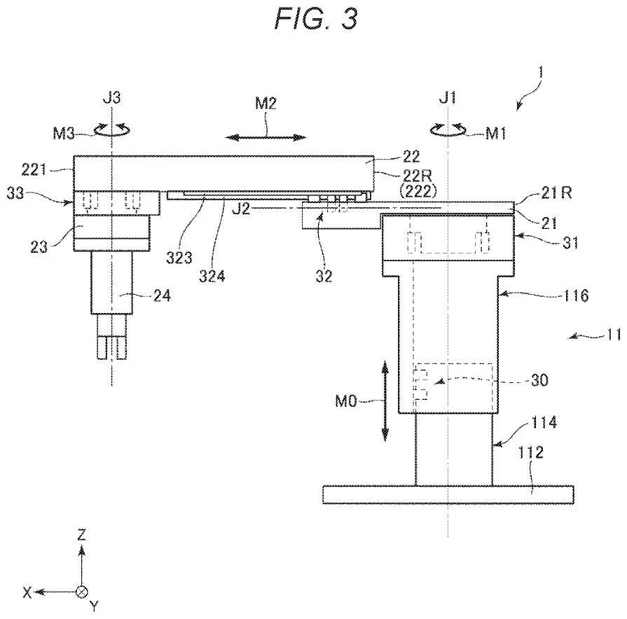

FIG. 1 is a side view showing the horizontal articulated robot according to the first embodiment and showing a state in which a second arm is contracted with respect to a first arm. FIG. 2 is a sectional view enlarging and showing the vicinity of a coupling section of a base and the first arm shown in FIG. 1. FIG. 3 is a side view showing the horizontal articulated robot according to the first embodiment and showing a state in which the second arm is extended with respect to the first arm.

The horizontal articulated robot 1 shown in FIGS. 1 and 3 is a so-called SCARA robot. A use of the horizontal articulated robot 1 is not particularly limited. Examples of the use of the horizontal articulated robot 1 include supply, removal, conveyance, and assembly of objects such as a precision instrument and components configuring the precision instrument.

The horizontal articulate robot 1 shown in FIGS. 1 and 3 includes a base 11, a first arm 21 coupled to the base 11, a second arm 22 coupled to the first arm 21, a third arm 23 coupled to the second arm 22, and an end effector 24 coupled to the third arm 23. The first arm 21 turns with respect to the base 11 around a turning axis J1 that passes through the base 11. The second arm 22 translates, that is, slides along a sliding axis J2 along which the first arm 21 extends. The horizontal articulated robot 1 includes, as shown in FIG. 1, piezoelectric actuators 321 configured to generate a driving force for sliding the second arm 22 with respect to the first arm 21.

In the figures of this application, for convenience of explanation, an axis parallel to the sliding axis J2 is represented as an X axis, an axis parallel to the turning axis J1 is represented as a Z axis, and an axis orthogonal to both of the X axis and the Y axis is represented as a Y axis. The distal ends of arrows indicating the axes are referred to as distal ends of the axes. Proximal ends of the arrows are referred to as proximal ends of the axes. Further, in the following explanation, for convenience of explanation, the distal end side of the Z axis is referred to as “upper” as well and the proximal end side of the Z axis is referred to as “lower” as well.

In such a horizontal articulated robot 1, the end effector 24 can be moved to a target position by combining a turning movement of the first arm 21 around the turning axis J1 and a sliding movement of the second arm 22 along the sliding axis J2. Since the second arm 22 extends and contracts along the sliding axis J2 with respect to the first arm 21, for example, when the first arm 21 is turned, the second arm 22 can be contracted. Consequently, when the first arm 21 turns in a contracted state of the second arm 22, it is possible to reduce sweeping areas of the first arm 21 and the second arm 22. In other words, a rotation radius of the end effector 24 can be reduced. Accordingly, it is possible to realize the horizontal articulated robot 1 that less easily interferes with an obstacle and the like even when the horizontal articulated robot 1 is set in a narrow place.

The sections of the horizontal articulated robot 1 are explained below.

### 1.1 Base

The base 11 shown in FIGS. 1 and 3 includes a base lower part 114 and a base upper part 116 provided on the base lower part 114. The base 11 is provided on a pedestal 112 set on a setting surface 10. The base lower part 114 is provided between the pedestal 112 and the base upper part 116. Examples of the setting surface 10 include a floor, a wall, a ceiling, a table, and a movable track. In other words, the setting surface 10 does not need to be a horizontal surface and may be, for example, a vertical surface. Therefore, “horizontal” of the horizontal articulated robot 1 means “parallel” to the setting surface 10.

The pedestal 112 is formed in a tabular shape. The lower surface of the pedestal 112 is in contact with the setting surface 10. The base lower part 114 is set on the upper surface of the pedestal 112.

The external shape of the base lower part 114 is formed in, for example, a columnar shape. The inside of the base lower part 114 may be a hollow. In that case, a controller that controls the operations of the sections of the horizontal articulated robot 1, a power supply device that supplies electric power to the sections of the horizontal articulated robot 1, and the like can be incorporated in the inside of the base lower part 114. The controller, the power supply device, and the like may be provided on the outside of the base lower part 114.

The base upper part 116 is formed in a tubular shape including an inner hollow part 116a. The base lower part 114 can be inserted into the inner hollow part 116a. Consequently, the base upper part 116 can be displaced along the Z axis by inserting and removing the base lower part 114 into and from the inner hollow part 116a. As a result, the base 11 is capable of extending and contracting along the turning axis J1.

The base 11 includes a driving device 30 provided in an upper part of the base lower part 114. The driving device 30 according to this embodiment includes piezoelectric actuators 301 including piezoelectric elements. When the piezoelectric elements included in the piezoelectric actuators 301 are energized, the piezoelectric elements vibrate to generate a driving force for sending out the base upper part 116 in the up-down direction.

Further, the driving device 30 includes a section to be driven 302 provided in the inner hollow part 116a and fixed to the base upper part 116. The section to be driven 302 is formed in a long shape that extends along the turning axis J1 (the Z axis). The section to be driven 302 receives a driving force generated by the piezoelectric actuators 301 and is displaced up and down with respect to the piezoelectric actuators 301. Consequently, as indicated by an arrow M0 in FIGS. 1 and 3, the base upper part 116 can be linearly moved up and down with respect to the base lower part 114. Consequently, the base upper part 116 and the sections coupled to the base upper part 116 can be lifted and lowered.

As explained above, the base 11 according to this embodiment extends and contracts along the turning axis J1. Consequently, the end effector 24 coupled to the third arm 23 can be displaced up and down. The end effector 24 can be moved to a target position. Since the base 11 supports the first arm 21, the second arm 22, and the like, the external shape and the like of the base 11 need to be formed relatively large. Accordingly, it is possible to prevent an increase in the size of the entire horizontal articulated robot 1 by giving an extending and contracting function to the base 11. Further, an arm having an extending and contracting function may be provided between the third arm 23 and the end effector 24. However, in that case, the mass of a portion away from the turning axis J1 increases. Then, since torque necessary for the turning of the second arm 22 increases, this embodiment is suitable from such a point of view as well.

The driving device 30 may include linearly moving mechanisms, for example, electromagnetic actuators other than the piezoelectric actuators 301. On the other hand, since the piezoelectric actuators 301 can achieve a reduction in the size of the driving device 30, the piezoelectric actuators 301 contribute to a reduction in the size of the horizontal articulated robot 1 as well. When the piezoelectric actuators 301 are used, it is possible to omit a mechanism that transmits a driving force of a speed reducer or the like. Therefore, from this point of view as well, it is possible to achieve a reduction in the size and simplification of the structure of the horizontal articulated robot 1.

When the arm having the extending and contracting function is provided between the third arm 23 and the end effector 24, the extending and contracting function of the base 11 may be omitted.

### 1.2 First Arm

The first arm 21 shown in FIG. 1 is coupled to the upper end of the base 11 via a driving device 31 explained below. As shown in FIG. 1, the first arm 21 is formed in a shape having a long axis that extends along the X axis. The first arm 21 turns around the turning axis J1. The first arm 21 crosses the turning axis J1 in a position deviating from the center of the long axis. Accordingly, the first arm 21 turns around the decentered turning axis J1.

The turning axis J1 is an axis that passes through the base 11 and is parallel to the Z axis. By turning the first arm 21 around the turning axis J1 that passes through the base 11 in this way, the second arm 22 sliding with respect to the first arm 21 can also be turned around the turning axis J1. Consequently, the sliding axis J2, which is an axis along which the second arm 22 slides, can also be turned around the turning axis J1.

A driving device 31 is interposed between the base 11 and the first arm 21. The first arm 21 can be turned with respect to the base 11 by a driving force generated by the driving device 31.

The driving device 31 shown in FIG. 2 includes a base coupling section 311 coupled to the base 11, a section to be driven 312 coupled to the first arm 21, piezoelectric actuators 313 fixed to the base coupling section 311, and a bearing 314 provided between the base coupling section 311 and the section to be driven 312. When piezoelectric elements included in the piezoelectric actuators 313 are energized, the piezoelectric elements vibrate to generate a driving force in a tangential direction of a circle centering on the turning axis J1. The section to be driven 312 receives the driving force generated by the piezoelectric actuators 313 and turns with respect to the piezoelectric actuators 313. Consequently, as indicated by an arrow M1 in FIG. 1, the first arm 21 can be turned around the turning axis J1.

The base coupling section 311 shown in FIG. 2 includes a recess 311a opened upward. The section to be driven 312, the piezoelectric actuators 313, and the bearing 314 are housed in the recess 311a. Consequently, it is possible to realize a reduction in the height of the driving device 31 while securing the rigidity of the driving device 31.

The section to be driven 312 shown in FIG. 2 is formed in a cylindrical shape having the turning axis J1 as a center axis. A step is provided in a part of the outer side surface of the section to be driven 312. A surface to be driven 312a is provided in the step. The piezoelectric actuators 313 come into contact with the surface to be driven 312a and receive a driving force.

As explained above, the piezoelectric actuators 313 shown in FIG. 2 generate a driving force in the tangential direction of the circle centering on the turning axis J1. The number of the piezoelectric actuators 313 included in the driving device 31 is not particularly limited and may be one or may be plural.

The bearing 314 shown in FIG. 2 includes an outer ring 314a coupled to the base coupling section 311, an inner ring 314b coupled to the section to be driven 312, and a rolling body 314c provided between the outer ring 314a and the inner ring 314b. A type of the bearing 314 is not particularly limited. Examples of the type of the bearing 314 include a ball bearing, a roller bearing and a cross roller bearing. The cross roller bearing is preferably used from the point of view of load bearing.

The piezoelectric actuators 313 may be substituted by any turning mechanisms, for example, electromagnetic motors. On the other hand, since the piezoelectric actuators 313 can achieve a reduction in the size and a reduction in the thickness of the driving device 31, the piezoelectric actuators 313 have an advantage that the piezoelectric actuators 313 contribute to a reduction in the size of the horizontal articulated robot 1. When the piezoelectric actuators 313 are used, since a mechanism for transmitting a driving force of a speed reducer or the like can be omitted, from such a point of view as well, it is possible to achieve a reduction in the size and simplification of the structure of the horizontal articulated robot 1.

### 1.3 Second Arm

The second arm 22 shown in FIG. 1 is set above the first arm 21 via a driving device 32. As shown in FIG. 1, the second arm 22 is formed in a shape having a long axis that extends along the X axis. The second arm 22 slides with respect to the first arm 21. Specifically, the second arm 22 is displaced along the X axis by a driving force generated by the driving device 32. Consequently, the second arm 22 slides along the sliding axis J2 along which the first arm 21 extends.

When the second arm 22 is located on the most proximal end side of the X axis in a sliding range of the second arm 22, that is, when the second arm 22 is in a state shown in FIG. 1, a right end 21R of the first arm 21 and a right end 22R of the second arm 22 are aligned with each other as shown in FIG. 1.

On the other hand, when the second arm 22 is located at the most distal end side of the X axis in the sliding range of the second arm 22, that is, when the second arm 22 is in a state shown in FIG. 3, the right end 21R of the first arm 21 and the right end 22R of the second arm 22 deviate from each other as shown in FIG. 3.

Since the second arm 22 slides with respect to the first arm 21 in this way, the second arm 22 has an extending and contracting function. FIG. 1 shows a contracted state of the second arm 22. FIG. 3 shows an extended state of the second arm 22.

In the horizontal articulated robot 1 explained above, for example, when the end effector 24 is moved toward the distal end side of the X axis, the second arm 22 only has to be simply extended. When the end effector 24 is moved in that way, the length along the Y axis of the horizontal articulated robot 1 does not change. Accordingly, even when an obstacle is present beside the Y axis in the horizontal articulated robot 1, it is possible to cause the horizontal articulated robot 1 to perform work while avoiding contact of the obstacle and the second arm 22 and the like.

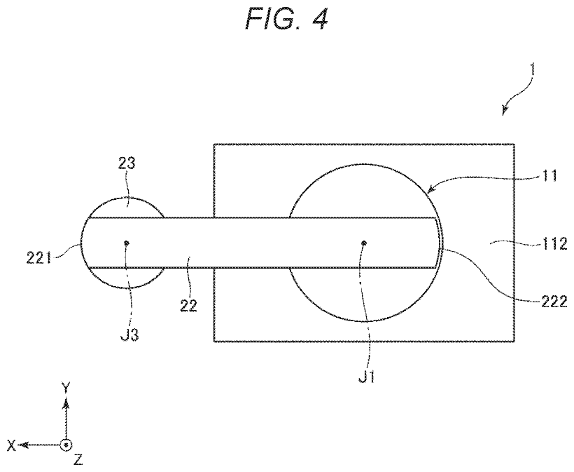

FIG. 4 is a plan view of the horizontal articulated robot 1 shown in FIG. 1 viewed from the axial direction of the turning axis J1.

In the horizontal articulated robot 1, as shown in FIG. 4, when the second arm 22 is in the contracted state, the second arm 22 overlaps the base 11. Since such structure is adopted, the length along the X axis at the time when the second arm 22 is in the contracted state can be reduced. In other words, when the second arm 22 is in the contracted state, a space above the base 11 can be used as a space for housing the contracted second arm 22.

In the extended state of the second arm 22, in the plan view from the axial direction of the turning axis J1, the second arm 22 may or may not overlap the base 11. However, when the second arm 22 overlaps the base 11, the area of an overlapping portion of the second arm 22 in the extended state and the base 11 is smaller than the area of an overlapping portion of the second arm 22 in the contracted state and the base 11.

The driving device 32 is interposed between the first arm 21 and the second arm 22.

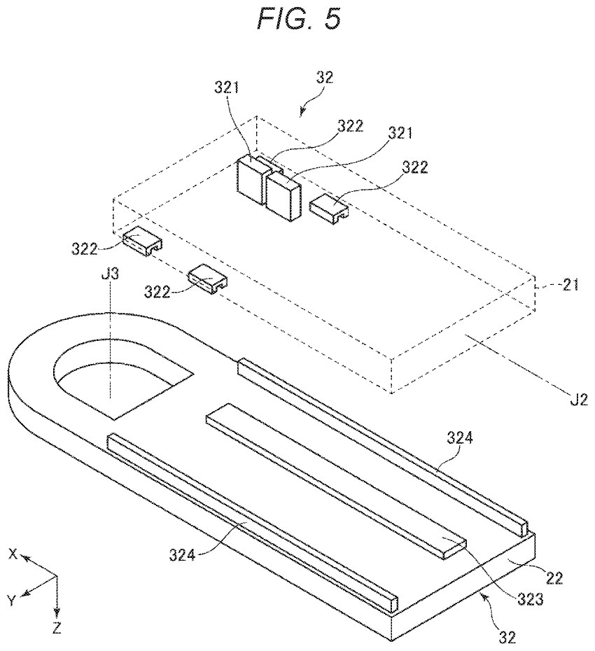

FIG. 5 is an exploded perspective view of the first arm 21, the second arm 22, and the driving device 32 shown in FIG. 1. In FIG. 5, the arm 21 is seen through and illustrated.

The driving device 32 shown in FIG. 5 includes the piezoelectric actuators 321 and guide blocks 322 provided in the first arm 21 and a section to be driven 323 and guide rails 324 provided in the second arm 22.

The driving device 32 shown in FIG. 5 is a linearly moving mechanism including the piezoelectric actuators 321 as driving sources. The piezoelectric actuators 321 include piezoelectric elements. When the piezoelectric elements are energized, the piezoelectric elements vibrate to generate a driving force for sending out the section to be driven 323 along the X axis. The section to be driven 323 receives the driving force generated by the piezoelectric actuators 321 and is linearly displaced with respect to the first arm 21. Consequently, as indicated by an arrow M2 in FIG. 1, the second arm 22 can be linearly moved along the sliding axis J2. Since the piezoelectric actuators 321 can achieve a reduction in the size of the driving device 32, the piezoelectric actuators 321 contribute to a reduction in the size of the horizontal articulated robot 1.

The number of the piezoelectric actuators 321 included in the driving device 32 is not particularly limited and may be one or may be plural.

The driving device 32 may include a mechanism for relaying and transmitting the driving force generated from the piezoelectric actuators 321. However, in this embodiment, the driving force generated from the piezoelectric actuators 321 is directly transmitted to the section to be driven 323. That is, the second arm 22 is slid with respect to the first arm 21 by direct drive. With such a configuration, the mechanism for relaying and transmitting the driving force is unnecessary. Therefore, it is possible to simplify the structure of the driving device 32 and achieve a reduction in the size of the driving device 32.

The section to be driven 323 shown in FIG. 5 is formed in a long shape that extends along the sliding axis J2. The guide rails 324 shown in FIG. 5 are also formed in a long shape that extends along the sliding axis J2. Further, the guide blocks 322 shown in FIG. 5 engage with the guide rails 324 provided in the second arm 22 and slide with respect to the guide rails 324. Consequently, it is possible to accurately linearly move the second arm 22 with respect to the guide rails 324. As a result, the end effector 24 can be accurately moved to a target position.

The numbers of the guide blocks 322 and the guide rails 324 included in the driving device 32 are not particularly limited and may be respectively one or may be respectively plural.

As explained above, the horizontal articulated robot 1 according to this embodiment includes the base 11, the first arm 21 configured to turn around the turning axis J1 that passes through the base 11, the second arm 22 provided in the first arm 21 and configured to slide with respect to the first arm 21 and extend and contract, and the driving device 32 including the piezoelectric actuators 321 (the driving sources) configured to generate a driving force for sliding the second arm 22 with respect to the first arm 21. When contracted, the second arm 22 overlaps the base 11 in the plan view from the axial direction of the turning axis J1.

With such a horizontal articulated robot 1, since the second arm 22 can be housed in the space above the base 11, when the second arm 22 is contracted, the length along the X axis of the horizontal articulated robot 1 can be reduced. Consequently, when the first arm 21 is turned around the turning axis J1, it is possible to sufficiently reduce the sweeping areas of the first arm 21 and the second arm 22. As a result, it is possible to set the horizontal articulated robot 1 and cause the horizontal articulated robot 1 to perform work even in a narrow place.

Since the second arm 22 can be housed in the space above the base 11, the entire length of the second arm 22 can be secured sufficiently long. Consequently, when the second arm 22 is extended, it is possible to sufficiently increase the distance from the base 11 to a most distant point to which the end effector 24 can reach along the sliding axis J2. As a result, it is possible to increase a workable range in the horizontal articulated robot 1 without increasing the entire length of the horizontal articulated robot 1 along the sliding axis J2. In other words, it is possible to realize the horizontal articulated robot 1 in which both of a reduction in size and expansion of a movable region are achieved.

“The second arm 22 overlaps the base 11” indicates a state in which a part of the second arm 22 overlaps the inner side of the outer edge of the base 11 in the plan view from the axial direction of the turning axis J1. The effects explained above can be expected more as there are more overlapping portions. For example, the turning axis J1 desirably passes through the second arm 22.

The second arm 22 according to this embodiment includes a distal end 221, which is a part that slides with respect to the first arm 21 to thereby have the longest distance from the turning axis J1 on the sliding axis J2 orthogonal to the turning axis J1, and a proximal end 222, which is a part most distant from the distal end 221 on the sliding axis J2. In other words, the distal end 221 is a part most distant from the turning axis J1 in the second arm 22 when the second arm 22 is extended most. In this embodiment, when the second arm 22 is in a most contracted state, that is, in a state in which the distance between the distal end 221 and the turning axis J1 is the shortest, the proximal end 222 overlaps the base 11 in the plan view from the axial direction of the turning axis J1.

With such a configuration, it is possible to prevent the proximal end 222 of the second arm 22 from protruding from the base 11 in the plan view. In other words, in FIG. 4, the proximal end 222 of the second arm 22 is prevented from protruding from the outer edge of the base 11. Consequently, in FIG. 4, even when an obstacle is present further on the proximal end side of the X axis than the base 11, it is possible to set the horizontal articulated robot 1 and cause the horizontal articulated robot 1 to perform work. In other words, it is possible to improve flexibility of disposition of the horizontal articulated robot 1.

As shown in FIGS. 1 and 3, the piezoelectric actuators 321 functioning as the driving sources included in the driving device 32 are provided in the arm 21 and deviate from the base 11 in a plan view from a direction perpendicular to the turning axis J1. Specifically, as shown in FIGS. 1 and 3, the piezoelectric actuators 321 are provided in positions deviating further to the left side than a position above the base 11 in the first arm 21. In other words, the piezoelectric actuators 321 are located side by side with the base 11 in the plan view from the direction perpendicular to the turning axis J1.

With such a configuration, compared with a case where the piezoelectric actuators 321 overlap the base 11, it is possible to secure a long distance between the piezoelectric actuators 321 and the turning axis J1 along the sliding axis J2. Accordingly, when the second arm 22 is extended by the driving device 32, it is possible to cause the distal end 221 of the second arm 22 to reach a more distant part. Since the piezoelectric actuators 321 are provided in the first arm 21, it is possible to reduce the weight of the second arm 22 and more smoothly slide the second arm 22.

Further, the first arm 21 is desirably capable of turning 360° around the turning axis J1. Specifically, since the first arm 21 according to this embodiment is coupled to the upper end of the base 11, it is unlikely that the first arm 21 interferes with the base 11. Accordingly, the first arm 21 can be rotated around the turning axis J1. Consequently, compared with a case where the first arm 21 cannot be rotated, it is possible to reduce a region that the end effector 24 cannot reach. It is possible to further expand the movable region of the horizontal articulated robot 1.

The piezoelectric actuators 321 may be substituted by any linearly moving mechanisms, for example, electromagnetic actuators.

### 1.4 Third Arm

The third arm 23 shown in FIG. 1 is coupled to the lower surface of the second arm 22 via a driving device 33. As shown in FIGS. 1 and 4, the external shape of the third arm 23 is formed in, for example, a columnar shape.

The driving device 33 shown in FIG. 1 has, for example, the same configuration as the configuration of the driving device 31 explained above. In other words, the driving device 33 includes piezoelectric actuators 331 coupled to the second arm 22 and a section to be driven 332 coupled to the third arm 23. The piezoelectric actuators 331 generate a driving force in a tangential direction of a circle centering on a turning axis J3. Consequently, the section to be driven 332 receives the driving force generated by the piezoelectric actuators 331 and turns with respect to the piezoelectric actuators 331. Consequently, as indicated by an arrow M3 in FIG. 1, it is possible to turn the third arm 23 around the turning axis J3.

### 1.5 End Effector

The end effector 24 shown in FIG. 1 is a mechanism having a gripping function such as a hand or a chuck. It is possible to grip work and perform various kinds of work by using such an end effector 24. The end effector 24 is not limited to the hand, the chuck, and the like and may be, for example, a vacuum suction mechanism including a suction pad or an electromagnetic attraction mechanism including an electromagnet.

### 2. Second Embodiment

The horizontal articulated robot 1 according to a second embodiment is explained.

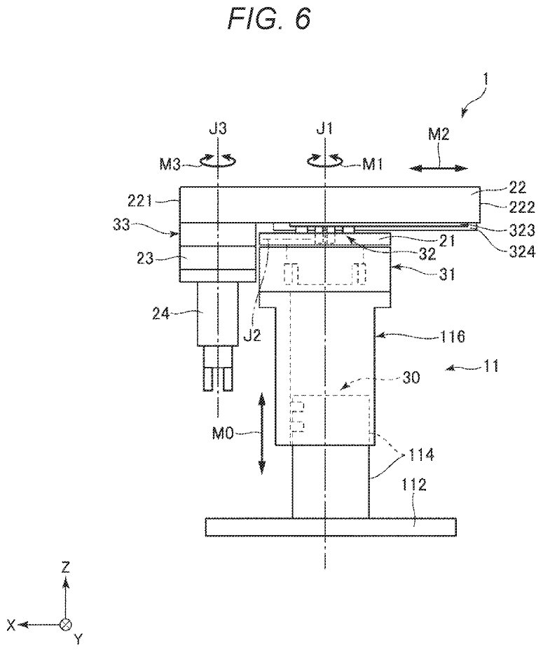

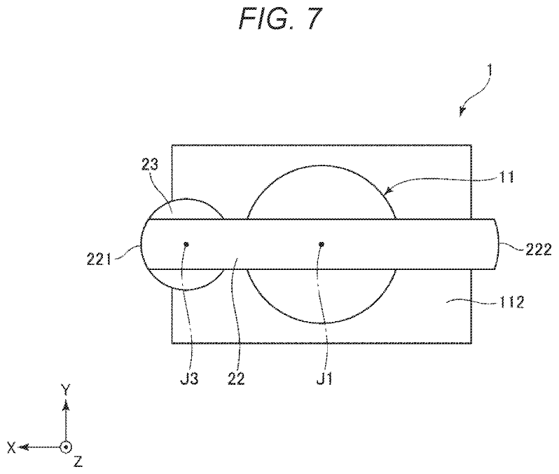

FIG. 6 is a side view showing the horizontal articulated robot according to the second embodiment and is a side view showing a state in which a second arm is contracted with respect to a first arm. FIG. 7 is a plan view of the horizontal articulated robot 1 shown in FIG. 6 viewed from the axial direction of the turning axis J1.

The second embodiment is explained below. In the following explanation, differences from the first embodiment are mainly explained. Explanation of similarities to the first embodiment is omitted. In FIGS. 6 and 7, the same components as the components in the first embodiment are denoted by the same reference numerals and signs.

The second embodiment is the same as the first embodiment except that the configuration of the first arm 21 is different.

In the first embodiment explained above, the first arm 21 is formed in the shape having the long axis extending along the X axis. On the other hand, in this embodiment, the first arm 21 is formed in a columnar shape overlapping the base 11. The driving device 32 including the piezoelectric actuators 321 is provided in such a first arm 21. Consequently, the piezoelectric actuators 321 overlap the base 11 in the plan view from the axial direction of the turning axis J1. Specifically, at least a part of the driving device 32 including the piezoelectric actuators 321 shown in FIGS. 6 and 7 is located at the inner side of the outer edge of the base 11.

With such a configuration, in a contracted state of the second arm 22, the proximal end 222 of the second arm 22 can be protruded from the base 11. Then, the distal end 221 of the second arm 22 can be brought closer to the turning axis J1. In other words, the end effector 24 can be moved to a position closer to the turning axis J1. As a result, it is possible to cause the end effector 24 to preform work in a region close to the base 11.

The second arm 22 according to this embodiment includes the distal end 221, which is a part that slides with respect to the first arm 21 to thereby have the longest distance from the turning axis J1 on the sliding axis J2 orthogonal to the turning axis J1, and the proximal end 222, which is a part most distant from the distal end 221 on the sliding axis J2. In this embodiment, when the second arm 22 is in a most contracted state, that is, in a state in which the distance between the distal end 221 and the turning axis J1 is the shortest, the distal end 221 and the proximal end 222 are located opposite to each other across the turning axis J1 in the plan view from the axial direction of the turning axis J1. In other words, the turning axis J1 is located between the distal end 221 and the proximal end 222.

With such a configuration, even if the entire length of the second arm 22 is increased, it is possible to reduce the distance between the distal end 221 of the second arm 22 and the turning axis J1. In other words, it is possible to increase the entire length of the second arm 22 and cause the distal end 221 to reach a more distant part and, on the other hand, move the distal end 221 to a position closer to the turning axis J1. Accordingly, it is possible to further expand a movable range of the end effector 24 along the sliding axis J2. As a result, it is possible to realize the horizontal articulated robot 1 in which both of a reduction in size and further expansion of a movable region are achieved.

In the second embodiment explained above, the same effects as the effects in the first embodiment are obtained.

### 3. Third Embodiment

The horizontal articulated robot 1 according to a third embodiment is explained.

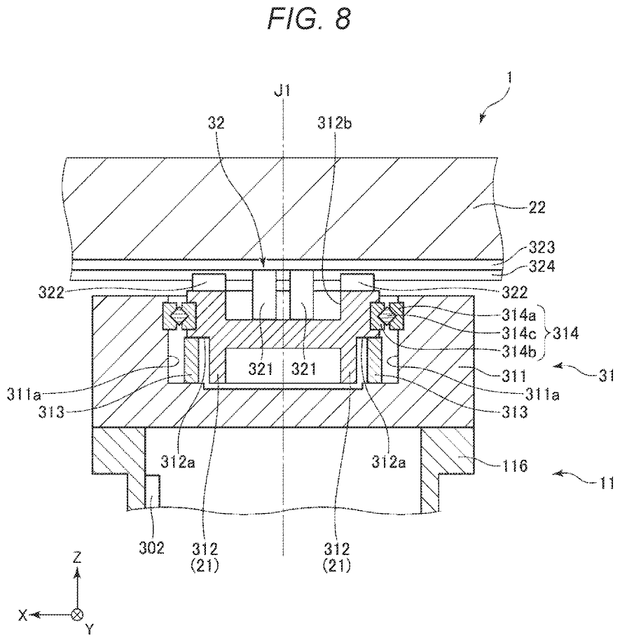

FIG. 8 is a partially enlarged sectional view showing the horizontal articulated robot according to the third embodiment.

The third embodiment is explained below. In the following explanation, differences from the second embodiment are mainly explained. Explanation of similarities to the second embodiment is omitted. In FIG. 8, the same components as the components in the second embodiment are denoted by the same reference numerals and signs.

The third embodiment is the same as the first embodiment except that the configurations of the first arm 21 and the driving device 31 are different.

The first arm 21 according to this embodiment is used as the section to be driven 312 according to the first embodiment as well. As shown in FIG. 8, the guide blocks 322 are coupled to the upper end of the first arm 21, which is the section to be driven 312.

On the other hand, as in the first embodiment, the piezoelectric actuators 321 shown in FIG. 8 are provided in the first arm 21, which is the section to be driven 312. However, parts of the piezoelectric actuators 321 are inserted into an inner hollow part 312b of the section to be driven 312.

More specifically, the driving device 31 included in the horizontal articulated robot 1 according to this embodiment includes the bearing 314 provided between the base 11 and the first arm 21. The bearing 314 includes the outer ring 314a coupled to the base coupling section 311, the inner ring 314b coupled to the section to be driven 312, and the rolling body 314c provided between the outer ring 314a and the inner ring 314b. The piezoelectric actuators 321 (the driving sources) are located in the inner hollow part 312b of the section to be driven 312 (the first arm 21) and on the inner side of the inner ring 314b.

With such a configuration, parts of the piezoelectric actuators 321 can be fit in the inner hollow part 312b. Consequently, it is possible to reduce the height of the horizontal articulated robot 1. In other words, it is possible to reduce the length along the Z axis of the horizontal articulated robot 1 and achieve a reduction in the size of the horizontal articulated robot 1.

In the third embodiment explained above, the same effects as the effects in the first and second embodiments are obtained.

The horizontal articulated robot according to the present disclosure is explained above based on the embodiments shown in the figures. However, the present disclosure is not limited to this. The components of the sections can be replaced with any components having the same functions. Any other components may be added to the embodiments.

In the embodiments, the turning axis J1 and the sliding axis J2 are orthogonal to each other. However, embodiments of the present disclosure are not limited to this. The turning axis J1 and the sliding axis J2 may cross at an angle other than being orthogonal.

What is claimed is:

1. A horizontal articulated robot comprising:
a base;
a first arm configured to turn around a turning axis that passes through the base;
a second arm provided in the first arm and configured to slide with respect to the first arm to extend and contract; and
a driving source configured to generate a driving force for causing the second arm to slide with respect to the first arm, wherein
when the second arm contracted, the second arm overlaps the base in a plan view from an axial direction of the turning axis.

2. The horizontal articulated robot according to claim 1, wherein
the driving source is provided in the first arm, and
the driving source is offset from the base in a plan view from a direction perpendicular to the turning axis.

3. The horizontal articulated robot according to claim 1, wherein
the driving source is provided in the first arm, and
the driving source overlaps the base in the plan view from the axial direction of the turning axis.

4. The horizontal articulated robot according to claim 3, further comprising a bearing provided between the base and the first arm and including an outer ring, an inner ring, and a turning body, wherein
the driving source is located at an inner side of the inner ring.

5. The horizontal articulated robot according to claim 1, wherein the second arm is slid with respect to the first arm by direct drive.

6. The horizontal articulated robot according to claim 1, wherein the driving source includes a piezoelectric actuator.

7. The horizontal articulated robot according to claim 1, wherein the base extends and contracts along the turning axis.

8. The horizontal articulated robot according to claim 1, wherein
the second arm includes a distal end, which is a part that slides with respect to the first arm to thereby have a longest distance from the turning axis on the sliding axis crossing the turning axis, and a proximal end, which is a part most distant from the distal end on the sliding axis, and
when a distance between the distal end and the turning axis is in a shortest state, the proximal end overlaps the base in the plan view from the axial direction of the turning axis.

9. The horizontal articulated robot according to claim 1, wherein
the second arm includes a distal end, which is a part that slides with respect to the first arm to thereby have a longest distance from the turning axis on the sliding axis crossing the turning axis, and a proximal end, which is a part most distant from the distal end on the sliding axis, and
when a distance between the distal end and the turning axis is in a shortest state, the turning axis is located between the distal end and the proximal end.

10. The horizontal articulated robot according to claim 1, wherein the first arm turns 360° around the turning axis.
